(19) United States
(12) Patent Application Publication
(10) Pub. No.: US 2007/0076580 A1
(43) Pub. Date: Apr. 5, 2007

(54) SIGNAL TRANSMITTING CIRCUIT

(75) Inventors: SHOU-KUO HSU, Tu-Cheng,Taipei Hsien (TW); CHENG-SHIEN LI, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,265

(22) Filed: Jul. 21, 2006

(30) Foreign Application Priority Data
Aug. 5, 2005 (CN) 200510036445.6

(51) Int. Cl. H04J 3/10

(52) U.S. Cl. 370/201; 375/296; 375/246

(57) ABSTRACT

An exemplary signal transmitting circuit includes a driving circuit, a main transmission line, a resistor, a node and a plurality of receiving circuits. The driving circuit is coupled to the node via the resistor and the main transmission line. Each of the receiving circuits is coupled to the node via an offshoot transmission line. The lengths of the offshoot transmission lines are generally equal to each other. It is of advantage that the signal transmitting circuit reduces signal reflections and maintains signal integrity.

### FIELD OF THE INVENTION

The present invention relates to computer systems, and more particularly to signal transmitting circuit on printed circuit board and method for designing same.

### DESCRIPTION OF RELATED ART

Signal integrity is an important factor to be taken into account when a printed circuit board (PCB) is designed. A well-designed PCB has an elevated on-off switching speed of integrated circuits, and a high density, compact layout of components. Parameters of the components and of the PCB substrate, a layout of the components on the PCB, and a layout of high-speed signal transmission lines all have an impact on signal integrity. In turn, proper signal integrity helps the PCB and an associated computer system to achieve stable performance. Impedance matching is considered an important part of signal integrity. Therefore a characteristic impedance of a transmission line is designed to match an impedance of a load associated with the transmission line. If the characteristic impedance of the transmission line is mismatched with the impedance of the load, signals arriving at a receiving terminal are apt to be partially reflected, causing a waveform of the signals to distort, overshoot, or undershoot.

Referring to FIG. 3, a diagram illustrating a conventional signal transmitting circuit coupling a north bridge chipset to three Peripheral Component Interconnect Extended (PCI-X) slots is shown. A north bridge chipset 10 is coupled to a main transmission line 16. A first PCI-X slot 12, a second PCI-X slot 13 and a third PCI-X slot 14 are coupled to the main transmission line 16 via terminal resistors R12˜R14 and offshoot transmission lines respectively. A distance of the second slot 13 to the north bridge chipset 10 is typically longer than the distance of the first slot 12 to the north bridge chipset 10, and the distance of the first slot 12 to the north bridge chipset 10 is typically longer than the distance of the third slot 14 to the north bridge chipset 10. The differences in length generally cause a waveform of the signals to be reflected, be distorted, overshoot, or undershoot. In FIG. 4, a graph is shown of signal waveforms using the circuit of FIG. 3. Line 122 denotes a signal waveform obtained at the first PCI-X slot 12, line 132 denotes a signal waveform obtained at the second PCI-X slot 13, and line 142 denotes a signal waveform obtained at the third PCI-X slot 14. As shown in FIG. 4, the lines 122, 132 and 142 do not superposition with respect to each other. Signal overshoot, undershoot, and ringing in the signal transmitting circuit of FIG. 3 is evident.

What is needed, therefore, is a signal transmitting circuit providing greater signal integrity.

### SUMMARY OF THE INVENTION

An exemplary signal transmitting circuit includes a driving circuit, a main transmission line, a resistor, a node and a plurality of receiving circuits. The driving circuit is coupled to the node via the resistor and the main transmission line. Each of the receiving circuits is coupled to the node via an offshoot transmission line. The lengths of the offshoot transmission lines are generally equal to each other.

It is of advantage that the signal transmitting circuit reduces signal reflections and maintains signal integrity.

Other advantages and novel features will become more apparent from the following detailed description of preferred embodiments when taken in conjunction with the accompanying drawings, in which:

### BRIEF DESCRIPTION OF THE DRAWINGS

FIG. 1 is a block diagram of a signal transmitting circuit in accordance with a preferred embodiment of the present invention;

FIG. 2 is a comparative graph showing signal waveforms obtained at each slot using the signal transmitting circuit of FIG. 1;

FIG. 3 is a block diagram of a conventional signal transmitting circuit coupling a north bridge chipset to three PCI-X slots; and

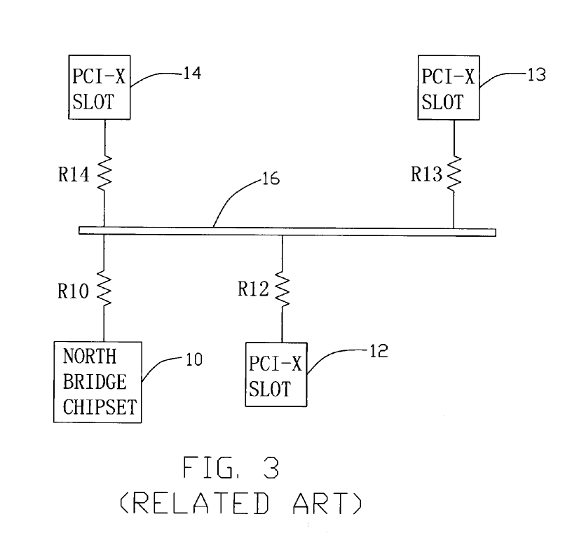

FIG. 4 is a comparative graph showing signal waveforms obtained at each slot using the signal transmitting circuit of FIG. 3.

### DETAILED DESCRIPTION OF THE INVENTION

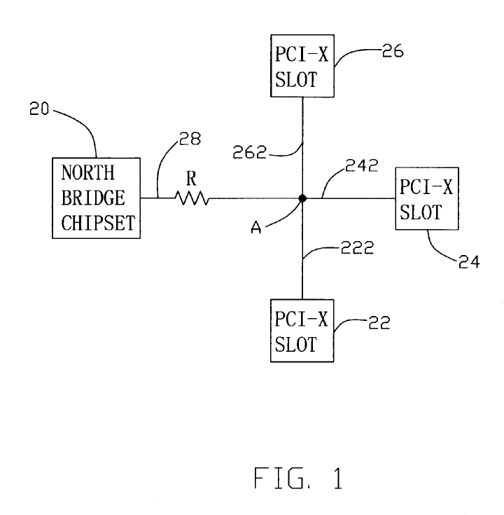

FIG. 1 shows a block diagram of a signal transmitting circuit in accordance with a preferred embodiment of the present invention. The signal transmitting circuit includes a north bridge chipset 20, a node A, a first Peripheral Component Interconnect Extended (PCI-X) slot 22, a second PCI-X slot 24, a third PCI-X slot 26, and a main transmission line 28. The north bridge chipset 20 is coupled to the node A via the main transmission line 28. The node A is coupled to the first PCI-X slot 22, the second PCI-X slot 24, and the third PCI-X slot 26 via offshoot transmission lines 222, 242, and 262 respectively.

A resistor R is connected between the north bridge chipset 20 and the node A. The resistor R is located nearer the north bridge chipset 20 than the node A. The resistance of the resistor R taken together with the internal resistance of the north bridge chipset 20 should be generally equal to the resistance of the main transmission line 28. In the above-described signal transmitting circuit of the preferred embodiment of the present invention, the resistance of the north bridge chipset 20 is about 24Ω, the resistance of the main transmission line 28 is about 56Ω, therefore the resistance of the resistor R is about 32Ω.

Generally, the length of the offshoot transmission lines 222, 242, and 262 are equal to each other but some variance is tolerable and may be calculated according to known formulas in the art.

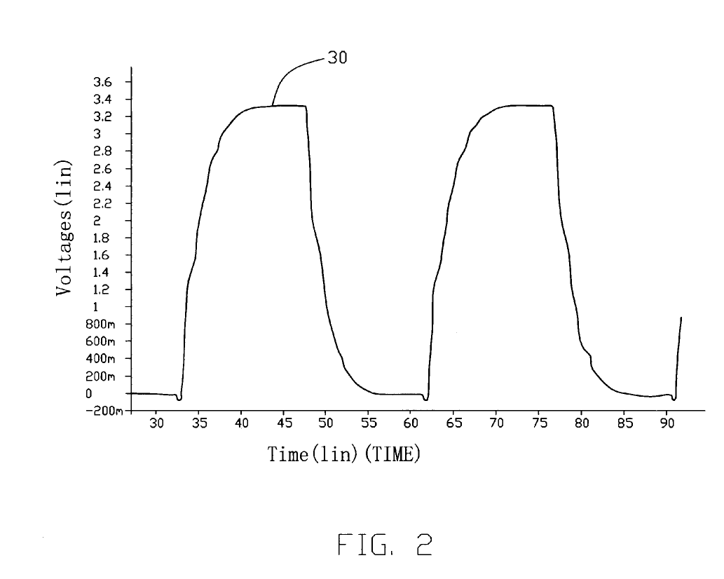

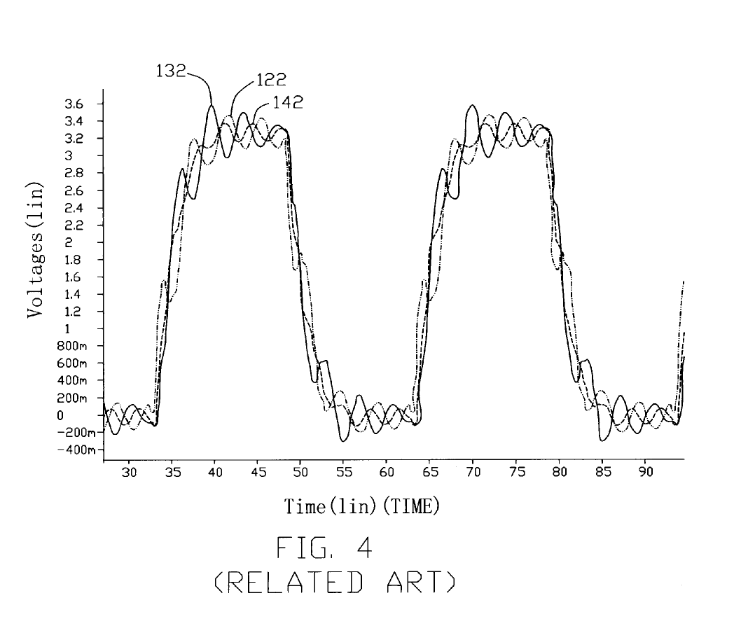

FIG. 2 is a graph showing signal waveforms obtained at each slot 22, 24, 26 using the signal transmitting circuit of FIG. 1. Line 30 is the composite waveform showing superposition of the signal waveforms obtained at the PCI-X slots 22, 24, and 26. Compared with FIG. 4, it can be seen that signal reflections are reduced and signal integrity is maintained.

In the above-described signal transmitting circuit of the preferred embodiment of the present invention, the north bridge 20, and the PCI-X slots 22, 24 and 26 are used as examples. In other embodiments, the signal transmission circuit with a resistor connected to the driving circuit may be used for any other signal transmission need on a PCB.

It is to be understood, however, that even though numerous characteristics and advantages of the present embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A signal transmitting circuit comprising:
a driving circuit;
a node coupled to the driving circuit via a main transmission line;
a plurality of receiving circuits receiving signals transmitted from the driving circuit, each of the receiving circuits coupled to the node via an offshoot transmission line; and
a resistor coupled between the driving circuit and the node, the resistor located nearer to the driving circuit than the node.

2. The signal transmitting circuit as claimed in claim 1, wherein the driving circuit is a north bridge chipset.

3. The signal transmitting circuit as claimed in claim 1, wherein the plurality of receiving circuits comprises three Peripheral Component Interconnect Extended slots.

4. The signal transmitting circuit as claimed in claim 1, wherein a resistance of the resistor together with a resistance of the driving circuit is approximately equal to a resistance of the main transmission line.

5. The signal transmitting circuit as claimed in claim 1, wherein the length of the offshoot transmission lines are approximately equal to each other.

6. A layout method of a printed circuit board (PCB) comprises the steps of:
setting a driving circuit and a plurality of receiving circuits on the PCB;
coupling the driving circuit to a node via a resistor and a main transmission line; and
coupling each of the receiving circuits to the node via an offshoot transmission line.

7. The layout method as claimed in claim 6, wherein the driving circuit is a north bridge chipset.

8. The layout method as claimed in claim 6, wherein the plurality of receiving circuits comprises three Peripheral Component Interconnect Extended slots.

9. The layout method as claimed in claim 6, wherein the resistance of the resistor is suited to a resistance of the main transmission line.

10. The layout method as claimed in claim 6, wherein the lengths of the offshoot transmission lines are generally equal to each other.
